(19) United States
(12) Patent Application Publication
(10) Pub. No.: US 2006/0285713 A1
(43) Pub. Date: Dec. 21, 2006

(54) Microphone structure

(76) Inventor: Chen-Che Lin, Taipei (TW)

Correspondence Address: CHEN-CHE LIN, P.O. Box 26-757, Taipei, 106, TW

(21) Appl. No.: 11/142,218

(22) Filed: Jun. 2, 2005

(51) Int. Cl. H04R 25/00; H04R 11/04

(52) U.S. Cl. 381/355; 381/314

(57) ABSTRACT

A microphone structure used for a hand-free device is proposed. It includes a microphone unit having a controller and a clipping unit disposed at a rear side of the microphone unit to make the clipping unit and the microphone unit form a rear clip. The microphone structure can be clipped onto a user's clothing and it can thus be fastened at a proper position. It is favorable for sound reception. Moreover, the microphone structure has a simple structure and a low production cost.

### BACKGROUND OF THE INVENTION

1. Field of the Invention

The present invention is related to a microphone structure, and more particularly, to a microphone structure that is used for a hand-free device and is convenient to be clipped onto a user's clothing.

2. Description of Related Art

Hand-free devices are used extensively for mobile phones. Reference is made to FIG. 1. In general, a conventional hand-free device has an earphone 5 and a microphone 6. After the hand-free device is connected to a mobile phone 8 via a signal line 7, a user can put the earphone 5 into his or her ear. The earphone 5 converts electrical signals sent from the mobile phone 8 into audible sounds. The microphone 6 can be positioned near a user's mouth to receive the user's voice, convert the voice into electrical signals and deliver the electrical signals to the mobile phone 8. For example, a conventional “Hand-free device” is disclosed in Taiwan Patent No. 542500 issued on Jul. 11, 2003.

However, the microphone mentioned above does not remain steady at a proper position and wobbles easily. This is unfavorable for sound reception. Another conventional hand-free device (as shown in FIG. 2) has a clip 9 disposed on the signal line 7 near the microphone 6. The clip 9 can be clipped onto a user's clothing to fasten the microphone at a proper position. However, attaching the clip 9 to the signal line 7 complicates the overall structure. It is more inconvenient for assembly, and the cost of production is increased.

Accordingly, as discussed above, the prior art still has some drawbacks that could be improved upon. The present invention aims to resolve the drawbacks of the prior art.

### SUMMARY OF THE INVENTION

An objective of the present invention is to provide a microphone structure. The microphone structure of the present invention can be clipped onto a user's clothing and it can thus be fastened at a proper position. That is favorable for sound reception. The present invention uses the original housing of a microphone unit and a clipping unit to form a rear clip. It makes the overall structure simplified and reduces the cost.

For reaching the objective above, the present invention provides a microphone structure, including a microphone unit having a controller; and a clipping unit disposed at a rear side of the microphone unit to make the clipping unit and the microphone unit form a rear clip.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram showing a conventional hand-free device when in use;

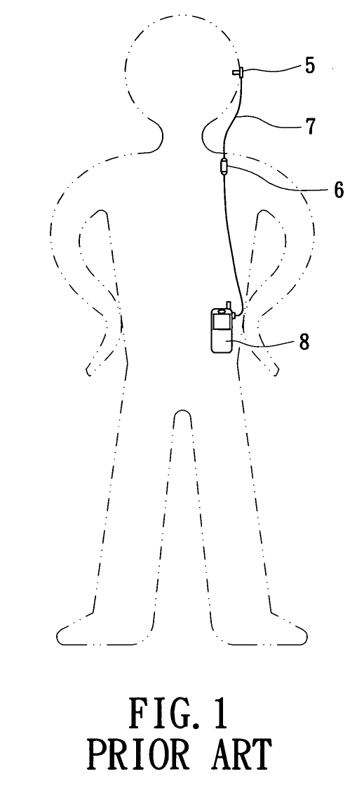

FIG. 2 shows an elevation view of another conventional hand-free device;

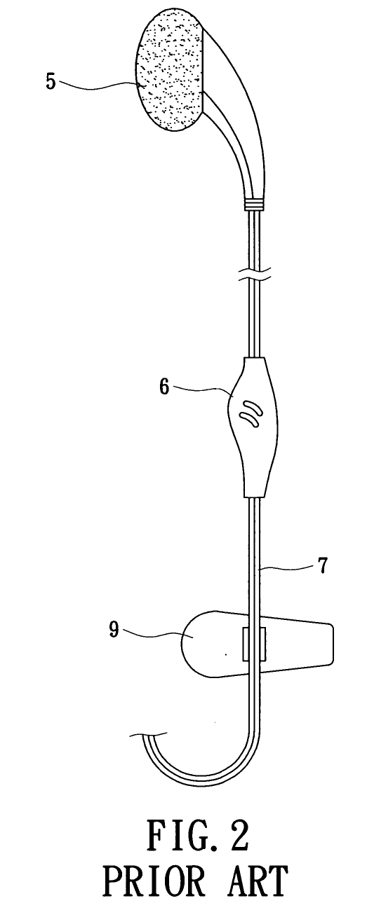

FIG. 3 shows an elevation view of a microphone in accordance with the present invention;

FIG. 4 shows an elevation view of another visual angle of the microphone in accordance with the present invention;

FIG. 5 is a front view of the microphone in accordance with the present invention;

FIG. 6 is a rear view of the microphone in accordance with the present invention;

FIG. 7 is a lateral view of the microphone in accordance with the present invention;

FIG. 8 shows the microphone of the present invention when in use;

FIG. 9 shows an elevation view of another embodiment of the microphone in accordance with the present invention; and

FIG. 10 shows the microphone of the present invention when its clipping unit is rotated.

### DETAILED DESCRIPTION OF PREFERRED EMBODIMENTS

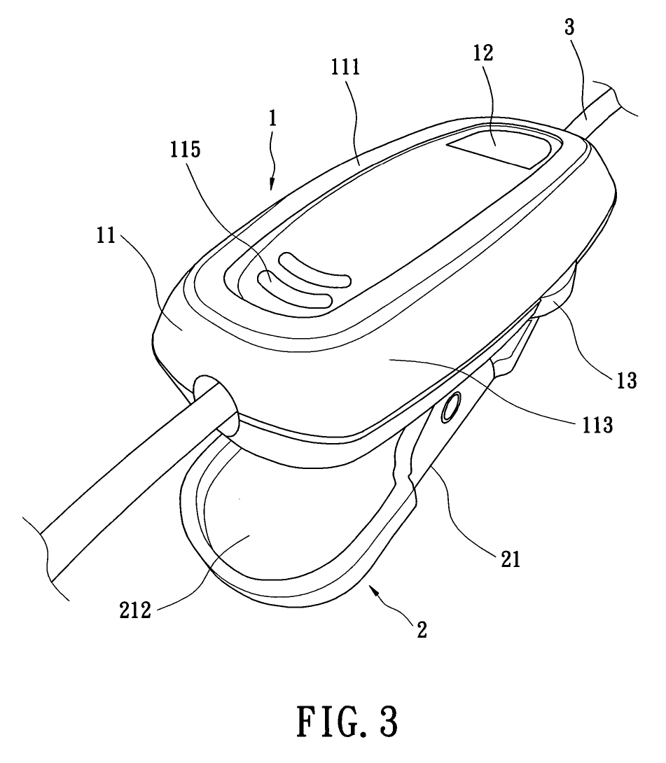

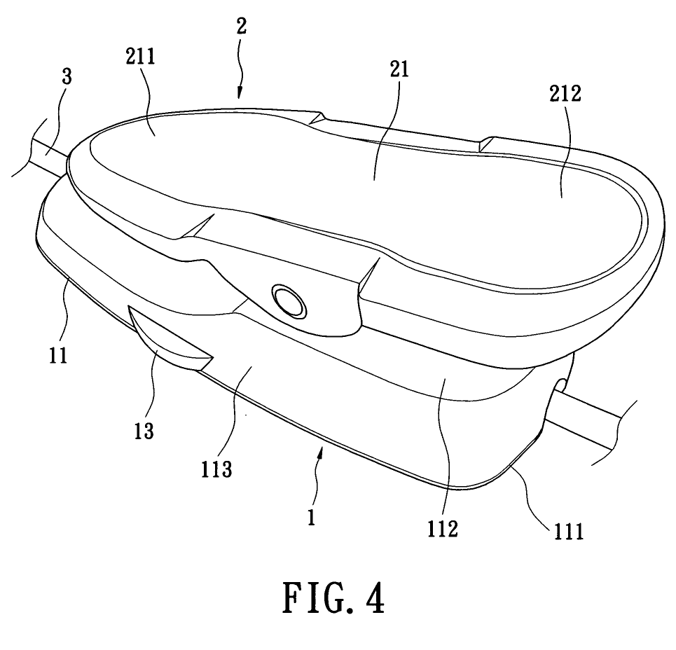

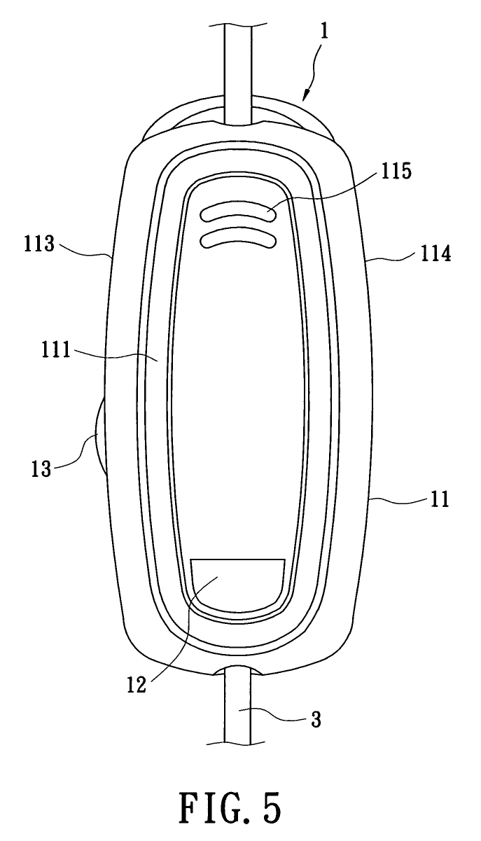

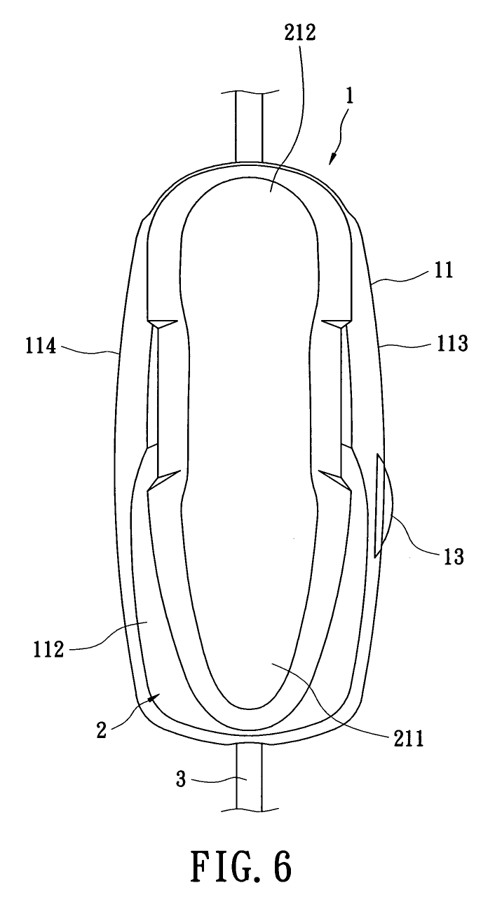

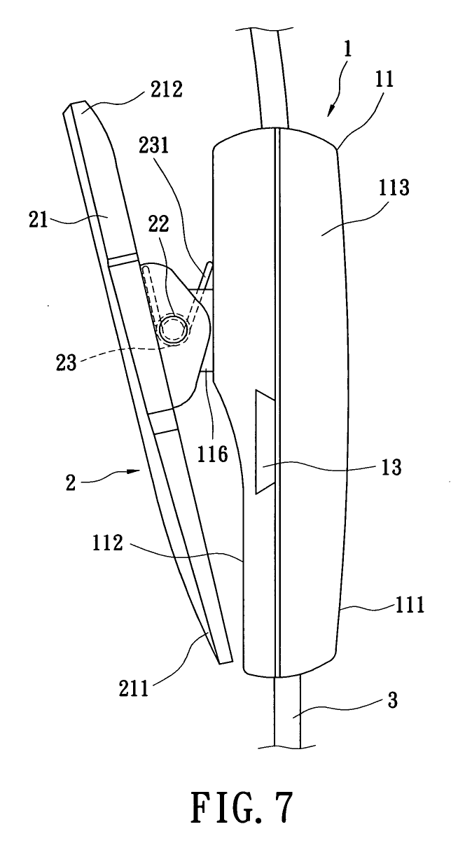

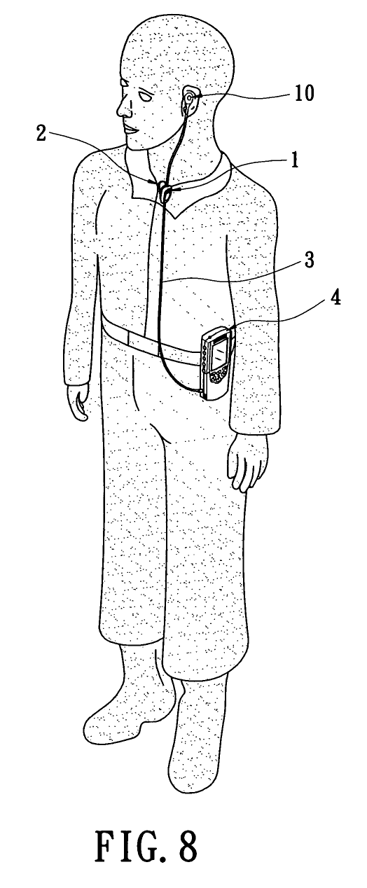

Reference is made to. FIGS. 3-7. The present invention provides a microphone structure, and more particularly, a microphone structure that is used for a hand-free device and can be conveniently clipped onto a user's clothing. It includes a microphone unit 1 and a clipping unit 2. The microphone unit 1 has a housing 11, which is a hollow housing made of a plastic material. The outer appearance of the housing 1 is unlimited and can be formed with various shapes that meet the practical requirements of a user. The housing 11 has a front side 111, a rear side 112, a left side 113 and a right side 114. The housing 11 has a proper microphone circuit inside (not shown). The microphone circuit is used to receive a user's voice and convert the voice into electrical signals. The electrical signals are transmitted to the mobile phone 4 via the signal line 3 electrically connected to the microphone circuit (as shown in FIG. 8). The microphone unit 1 is also connected to an earphone 10.

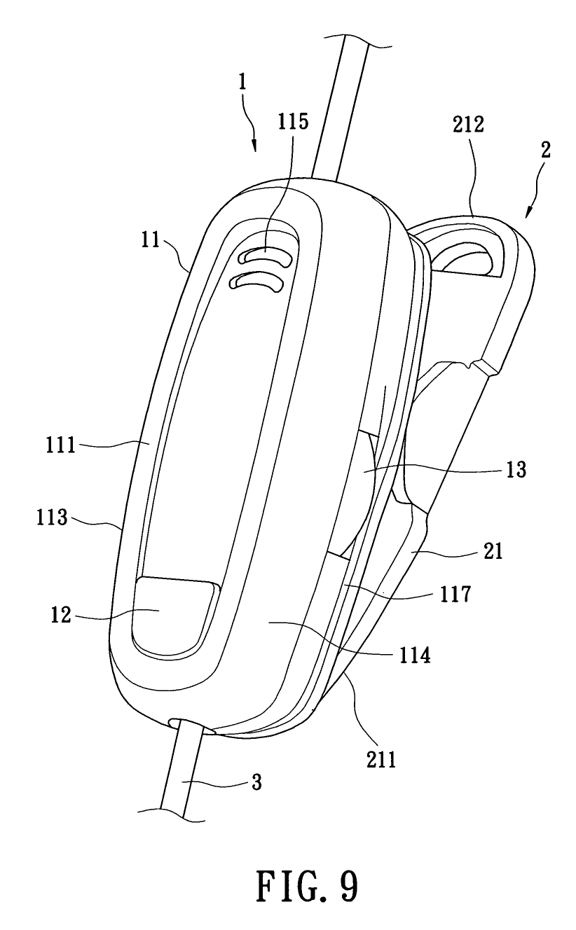

The front side 111 of the housing 11 has sound holes 115. The sound holes 115 communicate with the inner part of the housing 11. Thereby the circuit disposed inside the housing 11 can receive the user's voice successfully. The front side 11 and the left side 113 (or the right side 114 as shown in FIG. 9) of the housing 11 respectively have an answering button 12 and a volume button 13 disposed thereon. In this way, a controller is formed. The answering button 12 and the volume button 13 are electrically connected to the circuit inside the housing 11. One can press the answering button 12 to answer an incoming call of the mobile phone 4 and use the volume button 13 to control the sound volume. The positions of the answering button 12 and the volume button 13 are unlimited and can be disposed at any location on the housing 1. The microphone unit 1 is, the same as the prior art in substance. Since the microphone unit 1 is not a key point in the present invention, it is not detailed.

The clipping unit 2 is made of a plastic or metal material. The clipping unit 2 has a clipping plate 21, which is pivoted on a pivotal base 116 projecting from the rear side 112 of the housing 11 of the microphone unit 1. In this way, the clipping unit 2 is disposed at the rear of the microphone 1. One end of the clipping plate 21 is formed with a clipping portion 211 and the opposite end is formed with a pressing portion 212. The clipping plate 21 of the clipping unit 2 and the housing 11 of the microphone unit 1 are combined to form a rear clip. A torque spring 23 is disposed between the clipping plate 21 of the clipping unit 2 and the housing 11 of the microphone unit 1. The two legs 231 of the torque spring 23 are respectively against the inner side of the clipping plate 21 and the rear side 112 of the housing 11. The torque spring 23 pushes the clipping portion 211 of the clipping plate 21 to the rear side 112 of the housing 11 to provide a clipping force. The combination mentioned above forms the microphone structure of the present invention.

The present invention disposes a clipping unit 2 on the rear of the housing 11 of the microphone unit 1. The clipping unit 2 and the housing 11 of the microphone unit 1 thus form a rear clip. When one presses the pressing portion 212 formed at one end of the clipping plate 21 of the clipping unit 2, the clipping portion 211 formed at the other end of the clipping plate 21 is forced to leave the housing 11 of the microphone unit 1. When one releases the pressing portion 212 of the clipping plate 21, the torque spring 23 pushes the clipping portion 211 of the clipping plate 21 to the rear side 112 of the housing 11. In this way, the microphone structure of the present invention can be clipped onto a user's clothing (as shown in FIG. 8).

Since the microphone of the present invention can be clipped onto a user's clothing, it can be fastened at a proper position. That is favorable for sound reception. The present invention disposes a clipping unit 2 on the rear of the housing 11 of the microphone unit 1 to make the clipping unit 2 and the housing 11 of the microphone unit 1 form a rear clip. In this way, the overall structure is simplified and the cost of production is reduced.

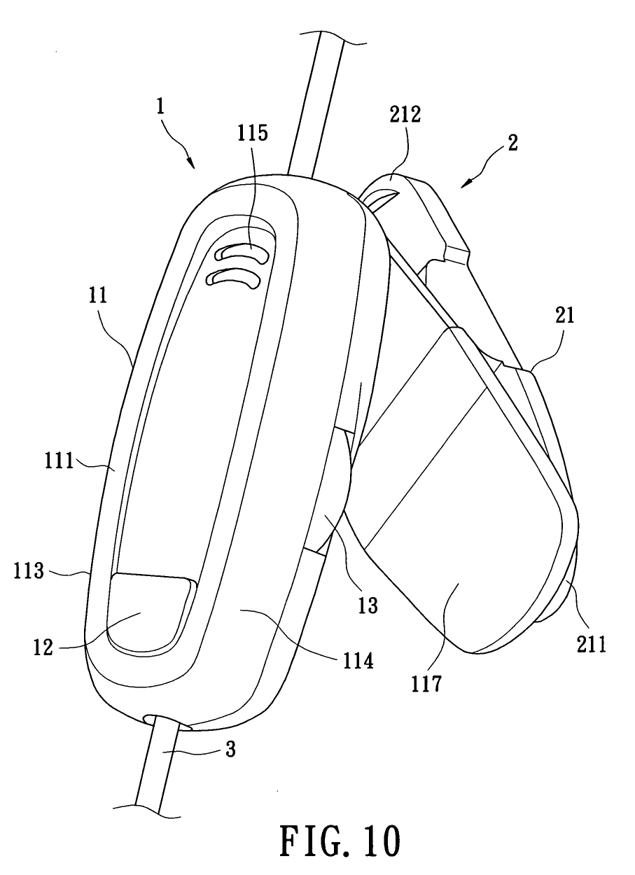

Furthermore, reference is made to FIGS. 9-10. In this embodiment, the rear side 112 of the housing 11 of the microphone unit 1 has a rotatable base 117 pivoted thereon. The clipping plate 21 of the clipping unit 2 is pivoted on the rotatable base 117. Thus, the clipping unit 2 can be rotated with the base 117 and the clipping unit 2 can be adjusted to various angles relative to the microphone unit 1 to make the present invention more convenient.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A microphone structure, used for a hand-free device, the microphone structure comprising:
a microphone unit having a controller; and
a clipping unit disposed at a rear side of the microphone unit to make the clipping unit and the microphone unit form a rear clip.

2. The microphone structure as claimed in claim 1, wherein the microphone unit has a housing, inside of which a circuit is disposed, the housing has sound holes, the clipping unit and the housing of the microphone unit form the rear clip.

3. The microphone structure as claimed in claim 1, wherein the controller includes an answering button and a volume button.

4. The microphone structure as claimed in claim 1, wherein the clipping unit has a clipping plate, which is pivoted on a pivotal base formed at the rear side of the microphone unit, the clipping plate has one end formed with a clipping portion and another end formed with a pressing portion.

5. The microphone structure as claimed in claim 1, wherein the rear side of the microphone unit has a rotatable base pivoted thereon, the clipping unit is disposed on the rotatable base.

6. The microphone structure as claimed in claim 1, further comprising a torque spring disposed between the clipping unit and the microphone unit to push the clipping unit to the rear side of the microphone unit to provide a clipping force.

7. The microphone structure as claimed in claim 1, further connecting to an earphone.
